(19) United States
(12) Patent Application Publication
(10) Pub. No.: US 2024/0313937 A1
(43) Pub. Date: Sep. 19, 2024

(54) METHOD FOR EARLY TERMINATION AND COMMUNICATION DEVICE

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/264,141

(22) PCT Filed: Feb. 5, 2021
(86) PCT No.: PCT/CN2021/075579

§ 371 Date: Aug. 3, 2023

(51) Int. Cl. H04L 5/16; H04W 72/232

(52) U.S. Cl. CPC H04L 5/16; H04W 72/232

(57) ABSTRACT

The present disclosure provides a method and an apparatus for an early termination, a device and a storage medium. The method scan include monitoring a PDCCH carrying DCI according to a time unit configured, and terminating a repeated transmission of the HD-FDD terminal according to indication information of a DCI information domain.

### CROSS-REFERENCE

The present application is a U.S. National Stage of International Application No. PCT/CN2021/075579, filed on Feb. 5, 2021, the entire content of which is incorporated herein by reference for all purposes.

### BACKGROUND

### Technical Field

The present disclosure relates to a field of mobile communication technologies, and more particularly, to a method and an apparatus for an early termination and, a device and a storage medium.

### Description of the Related Art

In LTE 4G systems, two major technologies, Machine Type Communication (MTC) and Narrow band Internet of things (NB-IoT), have been proposed to support IoT services. These two major technologies are mainly aimed at low-speed and high-latency scenarios, such as meter reading scenarios, and environmental monitoring scenarios.

### SUMMARY

According to a first aspect of the present disclosure, a method for an early termination is provided, performed by a half-duplex frequency division duplexing HD-FDD terminal, and the method includes monitoring, according to a time unit configured, a physical downlink control channel PDCCH carrying downlink control information DCI, and terminating, according to indication information of a DCI information domain, a repeated transmission of the HD-FDD terminal.

According to a second aspect of the present disclosure, a method for an early termination is provided, performed by a network device, and the method includes configuring an early termination function for an HD-FDD terminal, and indicating, through downlink control information DCI, the HD-FDD terminal to terminate a repeated transmission early.

According to a third aspect of the present disclosure, a communication device is provided and includes a processor, a transceiver, a memory and executable programs running on the processor. When the processor runs the executable programs, the method for the early termination according to the first aspect or the second aspect is performed.

Additional aspects and advantages of the embodiments of the present disclosure will be set forth in part in the following description, which will become apparent from the following description, or may be learned by practice of the present disclosure.

### BRIEF DESCRIPTION OF THE DRAWINGS

The above and/or additional aspects and advantages of the present disclosure will become apparent and easy to understand from the following description of embodiments in conjunction with the accompanying drawings, in which:

FIG. 1 is a flowchart of a method for an early termination according to an embodiment of the present disclosure;

FIG. 2 (a) is a schematic diagram of an early termination scenario according to an embodiment of the present disclosure;

FIG. 2 (b) is a schematic diagram of an early termination scenario according to another embodiment of the present disclosure;

FIG. 3 is a schematic diagram of an early termination scenario according to yet another embodiment of the present disclosure;

FIG. 4 is a schematic diagram of an early termination scenario according to still yet another embodiment of the present disclosure;

FIG. 5 is a flowchart of a method for an early termination according to another embodiment of the present disclosure;

FIG. 6 is a structural schematic diagram of an apparatus for an early termination proposed according to the present disclosure;

FIG. 7 is a structural schematic diagram of another apparatus for an early termination proposed according to the present disclosure; as well as

FIG. 8 is a structural block diagram of a communication device according to an embodiment of the present disclosure.

### DETAILED DESCRIPTION OF THE PREFERRED EMBODIMENTS

Embodiments of the present disclosure are described in detail below, examples of which are illustrated in the accompanying drawings, and the same or similar reference numerals denote the same or similar elements or elements having the same or similar functions throughout the drawings. The embodiments described below with reference to the accompanying drawings are exemplary, which are merely used to explain the present disclosure, and should not be construed as a limitation of the present disclosure.

In the related art, the NB-IoT may merely support a maximum rate of several hundred k at present, and the MTC may merely support a maximum rate of several M at present. However, on the other hand, with continuous development of the IoT services, such as the popularity of video surveillance, smart home, wearable devices, industrial sensor monitoring and other services, these services typically require a rate of tens to 100M, and also have relatively high requirements for latency. Therefore, it is difficult for the MTC technologies and the NB-IoT technologies in LTE to meet the requirements.

In the related art, a network speed is upgraded by enhancing coverage. For Redcap terminals that need coverage enhancement, a network may configure the terminal with an excessive quantity of repeated transmissions due to factors such as inaccurate measurement or channel fluctuations. On a network device, it is possible that data has been successfully demodulated before the terminal has sent all the repeated transmissions, and in this case, the network may send a reception confirmation indication to the terminal to indicate the terminal to stop the current repeated transmission. Such an operation is conducive to the energy saving of the terminal.

However, a working mechanism of the above early termination is that the terminal monitors a search space while sending data, and determines whether there is an indication of the early termination by monitoring the corresponding Downlink Control Information (DCI).

For an HD-FDD (Half-Duplex Frequency Division Duplexing), the terminal cannot monitor a Physical Downlink Control Channel (PDCCH) when sending the data. However, the present disclosure implements the HD-FDD based approach to support the early termination.

For clarity of description, the following description is focused on the method for the early termination of the present disclosure on an HD-FDD terminal and a network device such as a base station, respectively.

First, the description below focuses on the HD-FDD terminal.

FIG. 1 is a flowchart of a method for an early termination provided according to an embodiment of the present disclosure, and the method includes steps 101 and 102:

in step 101: a physical downlink control channel (PDCCH) carrying downlink control information (DCI) is monitored according to a time unit configured.

The DCI may be understood as control information related to a physical uplink and downlink shared channel transmitted by a PDCCH, and the DCI includes several related contents such as RB resource allocation information, a Modulation and Coding Scheme (MCS), a HARQ-ID and the like. Only when the terminal correctly decodes the DCI, may it correctly process Physical Downlink Shared Channel (PDSCH) data or Physical Uplink Shared Channel (PUSCH) data.

In the present embodiment, the sending of the indication information related to the early termination is carried through the DCI.

In the present embodiment, when the HD-FDD terminal is configured with an early termination function, the network also needs to configure some time units on which the terminal stops sending data, starts monitoring the downlink, and monitors whether there is an indication of the early termination.

In the present embodiment, the PDCCH carrying the downlink control information DCI is detected according to the time unit that is configured, and thus it is obviously that the relevant data is sent on other time units that are not configured.

in step 102, a repeated transmission of the HD-FDD terminal is terminated according to indication information of a DCI information domain.

In the present embodiment, if the indication information of the DCI information domain is monitored, as mentioned above, in the present embodiment, the indication information of the early termination is carried through the DCI. Thus, the repeated transmission of the HD-FDD terminal is terminated, to achieve the energy saving of the HD-FDD terminal.

It should be noted that the aforementioned DCI information domain may be understood as one or a plurality of bits in a DCI code stream and the like.

Of course, since the time unit in the present embodiment is used to monitor according to the time unit configured, in order to terminate early. Thus, in an embodiment of the present disclosure, the time unit configured is before an end of a repeated transmission that is configured.

To sum up, in the method for the early termination of the embodiment of the present disclosure, the PDCCH carrying the downlink control information DCI is monitored according to the time unit configured, and the repeated transmission of the HD-FDD terminal is terminated according to the indication information of the DCI information domain. Thus, in a scenario of the coverage enhancement, the energy saving of the HD-FDD terminal is achieved.

In the scenario of the coverage enhancement, in order to achieve the energy saving of the HD-FDD terminal, in the embodiment of the present disclosure, the PDCCH carrying the downlink control information DCI is monitored according to the time unit configured, and the repeated transmission of the HD-FDD terminal is terminated according to the indication information of the DCI information domain.

In practical applications, the time unit may be configured in different manners, such as the following examples:

### Example 1

In the example, the time unit is determined according to a preset protocol.

The preset protocol may be understood as any communication protocol that is agreed on.

### Example 2

In the example, a control signaling carrying the time unit is received, where the control signaling is sent by a network device such as a base station. Thus, in the present embodiment, the network device configures a monitoring time unit of a downlink for the terminal.

To sum up, the method for the early termination of the embodiment of the present disclosure may flexibly select the configuration manner of the time unit according to the needs of the scenario, which has high practicality.

In the scenario of the coverage enhancement, in order to achieve the energy saving of the HD-FDD terminal, in the embodiment of the present disclosure, the PDCCH carrying the downlink control information DCI is monitored according to the time unit configured, and the repeated transmission of the HD-FDD terminal is terminated according to the indication information of the DCI information domain. The time units herein correspond to different time intervals in different application scenarios, as shown in the following examples:

### Example 1

In the example, the PDCCH carrying the downlink control information DCI being monitored according to the time unit configured is that the PDCCH carrying the DCI starts to be monitored when at least one fixed time unit configured is reached. The fixed time unit may be any one or a plurality of time units before the end of the repeated transmission, and the plurality of fixed time units may be provided in intervals, consecutively, or a combination thereof.

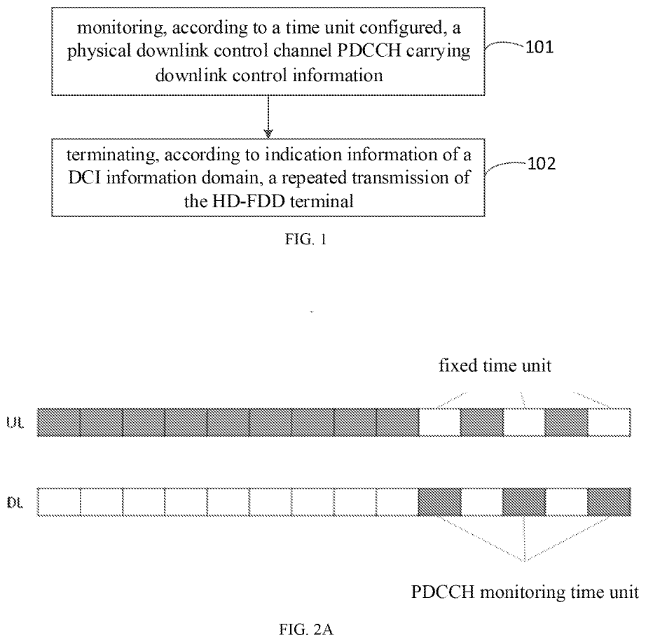

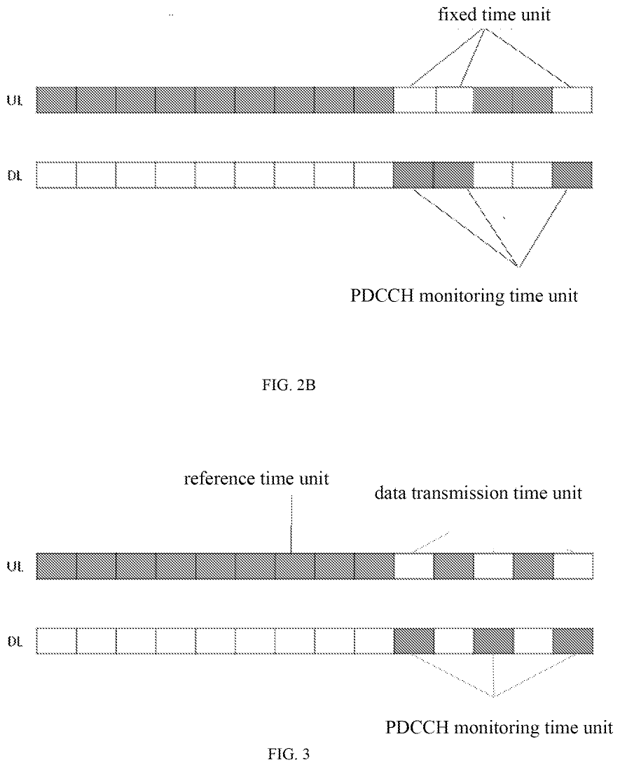

For example, referring to FIG. 2 (a), where UL in FIG. 2 (a) may be understood as a data sending time unit of an uplink, and DL may be understood as a monitoring time unit of a downlink. In FIG. 2, it contains three fixed time units arranged in intervals.

For example, as shown in FIG. 2 (b), it contains three fixed time units with first two time units being consecutive, and the two consecutive time units are arranged in intervals with a third fixed time unit.

### Example 2

In the example, the PDCCH carrying the DCI starts to be monitored after at least one reference time unit that is configured, that is, after the reference time unit, the monitoring function is activated to start monitoring the PDCCH carrying the DCI. In the present embodiment, the PDCCH carrying the DCI may be monitored according to a part of the monitoring time units that are pre-configured after the reference time unit, or the PDCCH carrying the DCI may also be monitored by using each time unit after the reference time unit corresponding to a current quantity of transmissions.

In some possible examples, the reference time unit is related to a quantity of repeated transmissions that is configured by the HD-FDD terminal, such as determining the reference time unit as a time unit after half of the quantity of repeated transmissions is completed, or determining the reference time unit as the time unit after one-third of the quantity of repeated transmissions is completed, and the like.

For example, as shown in FIG. 3, the reference time unit is at a location greater than half of a total quantity of transmissions. When the reference location is reached, the PDCCH carrying the DCI starts to be monitored. In FIG. 3, three time units for monitoring the PDCCH carrying the DCI are preset in subsequent reference time units (time units in white regions of an uplink time unit in FIG. 3).

To sum up, in the method for the early termination of the embodiment of the present disclosure, the time unit for monitoring the PDCCH carrying the DCI is flexibly determined according to the needs of the scenario, which improves the flexibility for the time unit configuration.

Based on the above embodiments, when the terminal searches for space to monitor the PDCCH, in order to reduce a quantity of blind detections of the terminal, the terminal may only monitor a specific PDCCH.

In an embodiment of the present disclosure, a PDCCH carrying a target DCI format is monitored according to the time unit that is configured, and that is, a PDCCH carrying other control information is no longer detected, only the PDCCH carrying the target DCI format is detected.

In the present embodiment, the target DCI format varies in different application scenarios, and may be any format that is not fixed as a certain control information. In some possible embodiments, the target DCI format includes an uplink UL grant DCI format.

Referring to FIG. 4, in the present embodiment, among a large number of PDCCHs, the terminal only needs to monitor the PDCCH carrying the UL grant DCI format.

To sum up, the method for the early termination of the present disclosure implementation monitors the PDCCH carrying the target DCI format according to the time unit that is configured, reducing the quantity of blind detections on the terminal and further reducing the energy consumption of the terminal.

The description below focuses on a method for an early termination on a network device according to an embodiment of the present disclosure.

FIG. 5 is a flowchart of a method for an early termination according to another embodiment of the present disclosure, as shown in FIG. 5. The method includes steps 501 and 502:

in step 501, an early termination function for a HD-FDD terminal is configured.

In the present embodiment, in order to ensure that the HD-FDD terminal may achieve the early termination in the scenario of the coverage enhancement, the HD-FDD terminal is configured with the early termination function, such as sending a control signaling of the early termination to the HD-FDD terminal.

in step 502, the HD-FDD terminal is indicated to terminate a repeated transmission early through downlink control information DCI.

In the present embodiment, the downlink control information DCI is used to indicate the HD-FDD terminal to terminate the repeated transmission early, which expands the indication content of the DCI, such that the DCI may be used to indicate the terminal to terminate the repeated transmission early.

To sum up, in the method for the early termination according to the embodiment of the present disclosure, the network device configures the early termination function for the HD-FDD terminal, and then indicates the HD-FDD terminal to terminate the repeated transmission early through the downlink control information DCI. Thus, in the scenario of the repeated transmission, the HD-FDD terminal may achieve the early termination, so as to save energy.

In the actual application, the network device may use different manners to indicate the HD-FDD terminal to terminate the repeated transmission early through the downlink control information DCI.

In an embodiment of the present invention, the network device configures a time unit for monitoring the DCI for the HD-FDD terminal, in order to facilitate the monitoring of PDCCH carrying the downlink control information DCI based on the time unit monitoring. The time units herein correspond to different time intervals in different application scenarios, as shown in the following examples:

### Example 1

In the example, the PDCCH carrying the downlink control information DCI being monitored according to the time unit configured is that the PDCCH carrying the DCI starts to be monitored when at least one fixed time unit configured is reached. The fixed time unit may be any one or a plurality of time units before the end of the repeated transmission, and the plurality of fixed time units may be provided in intervals, consecutively, or a combination thereof.

### Example 2

In the example, the PDCCH carrying the DCI starts to be monitored after at least one reference time unit that is configured, that is, after the reference time unit, the monitoring function is activated to start monitoring the PDCCH carrying the DCI. In the present embodiment, the PDCCH carrying the DCI may be monitored according to a part of the monitoring time units that are pre-configured after the reference time unit, or the PDCCH carrying the DCI may also be monitored by using each time unit after the reference time unit corresponding to a current quantity of transmissions.

In some possible examples, the reference time unit is related to a quantity of repeated transmissions that is configured by the HD-FDD terminal, such as determining the reference time unit as a time unit after half of the quantity of repeated transmissions is completed, or determining the reference time unit as the time unit after one-third of the quantity of repeated transmissions is completed, and the like.

To sum up, in the method for the early termination in the embodiment of the present disclosure, the network device uses the time unit to indicate the HD-FDD terminal to terminate the repeated transmission early, achieving the early termination of the HD-FDD terminal in the scenario of the coverage enhancement, so as to save energy.

Based on the above embodiments, when the terminal searches for space to monitor the PDCCH, in order to reduce a quantity of blind detections of the terminal, the terminal may only monitor a specific PDCCH.

In an embodiment of the present disclosure, the network device indicates the HD-FDD terminal to terminate the repeated transmission early through the target DCI format, such that the terminal no longer detects a PDCCH carrying other control information, but only detects the PDCCH carrying the target DCI format.

In the present embodiment, the target DCI format varies in different application scenarios, and may be any format that is not fixed as a certain control information. In some possible embodiments, the target DCI format includes an uplink UL grant DCI format.

To sum up, in the method for the early termination according to the embodiment of the present disclosure, the network device indicates the HD-FDD terminal to terminate the repeated transmission early through the target DCI format, such that the terminal monitors the PDCCH carrying the target DCI format according to the time unit that is configured, reducing the quantity of blind detections on the terminal and further reducing the energy consumption of the terminal.

Based on the above embodiments, in order to flexibly meet different application scenarios, the manner in which the network device configures an early termination function for the HD-FDD terminal may be flexible and varied.

In some possible examples, the network device determines an early termination function not prohibiting the repeated transmission of the HD-FDD terminal according to an application scenario, and configures, in a case of being configurable, the early termination function for the HD-FDD terminal. Thus, the HD-FDD terminal may flexibly select whether to implement the early termination function according to the needs of the scenario.

For example, in some application scenarios, the HD-FDD terminal is sensitive to energy consumption. Thus, in order to achieve the energy saving, since the early termination function for the repeated transmission of the HD-FDD terminal is not prohibited, the current situation belongs to a configurable situation, and the early termination function is configured for the HD-FDD terminal.

In some possible examples, the network device determines the early termination function prohibiting the repeated transmission of the HD-FDD terminal according to the application scenario.

For example, the HD-FDD terminal sends relatively important data, and in order to ensure an efficiency of data transmission, it is necessary to ensure that each time unit is used for the data transmission. Thus, the network device determines the early termination function that prohibits the repeated transmission of the HD-FDD terminal according to the application scenario.

To sum up, in the method for the early termination according to the embodiment of the present disclosure, the network device may flexibly select whether to prohibit the early termination function for the repeated transmission of the HD-FDD terminal, to meet the needs of different scenarios.

Corresponding to the method for the early termination provided by the above embodiments, the present disclosure also provides an apparatus for an early termination. Since the apparatus for the early termination provided by embodiments of the present disclosure corresponds to the method for the early termination provided by the above several embodiments, the implementations of the method for the early termination are also applicable to the apparatus for the early termination provided in the embodiments, which will not be described in detail in the present embodiment.

FIG. 6 is a structural schematic diagram of an apparatus for an early termination proposed according to the present disclosure.

FIG. 6 is a structural schematic diagram of an apparatus for an early termination according to an embodiment of the present disclosure, which is applied to an HD-FDD terminal, as shown in FIG. 6. The apparatus for the early termination includes a monitoring module 610 and a termination module 620, wherein
the monitoring module 610, configured to monitor, according to a time unit configured, a PDCCH carrying downlink control information DCI;
the termination module 620, configured to terminate, according to indication information of the DCI information domain, a repeated transmission of the HD-FDD terminal.

To sum up, the apparatus for the early termination according to the embodiment of the present disclosure monitors the PDCCH carrying the downlink control information DCI according to the time unit that is configured, and terminates the repeated transmission of the HD-FDD terminal according to the indication information of the DCI information domain.

Thus, in the scenario of the coverage enhancement, the energy saving of the HD-FDD terminal is achieved.

Corresponding to the method for the early termination provided by the above embodiments, the present disclosure also provides an apparatus for an early termination. Since the apparatus for the early termination provided by embodiments of the present disclosure corresponds to the method for the early termination provided by the above several embodiments, the implementations of the method for the early termination are also applicable to the apparatus for the early termination provided in the embodiments, which will not be described in detail in the present embodiment.

FIG. 7 is a structural schematic diagram of another apparatus for an early termination proposed according to the present disclosure.

FIG. 7 is a structural schematic diagram of an apparatus for an early termination according to an embodiment of the present disclosure, which is applied on a network device, as shown in FIG. 7. The apparatus for the early termination includes a configuration module 710 and an indication module 720, wherein
the configuration module 710 configured to configure an early termination function for an HD-FDD terminal;
the indication module 720 configured to indicate, through downlink control information DCI, that the HD-FDD terminal terminates a repeated transmission early.

To sum up, in the apparatus for the early termination according to the embodiment of the present disclosure, the network device configures the early termination function for the HD-FDD terminal, and then indicates the HD-FDD terminal to terminate the repeated transmission early through the downlink control information DCI. Thus, in the scenario of the repeated transmission, the HD-FDD terminal may achieve the early termination, so as to save energy.

According to embodiments of the present disclosure, the present disclosure further provides a communication device and a non-transitory readable storage medium.

As shown in FIG. 8, which is a block diagram of a communication device for a method for an early termination according to an embodiment of the present disclosure, the communication device is intended to represent various forms of digital computers, such as a laptop, a desktop, a workstation, a personal digital assistant, a server, a blade server, a mainframe computer, and other suitable computers. The communication device may also represent various forms of mobile devices, such as a personal digital processor, a cellular phone, a smart phone, a wearable device, and other similar computing devices. The components shown herein, their connections and relationships, and their functions are described as examples only, and are not intended to limit implementations of the method for the early termination of the present disclosure described and/or claimed herein.

As shown in FIG. 8, the communication device may include: one or more processors 1401, a memory 1402, and interfaces configured to connect the respective components, including high-speed interfaces and low-speed interfaces. The respective components are interconnected using different buses and may be mounted at a common motherboard or in other manners as desired. The processor may process instructions for execution within the communication device, including instructions stored in or at the memory to display graphical information for a GUI at an external input/output apparatus, such as a display device coupled to the interface. In other implementations, a plurality of processors and/or a plurality of buses may be used with a plurality of memories, if desired. Likewise, a plurality of communication devices may be connected, with each device providing some of necessary operations (e.g., as a server array, a set of blade servers, or a multi-processor system). In FIG. 8, one processor 801 is taken as an example.

The memory 802 is configured as the non-transitory computer readable storage medium provided by the present disclosure. The memory stores instructions executable by the at least one processor to cause the at least one processor to perform the method for the early termination provided by the present disclosure. The non-transitory computer readable storage medium according to the present disclosure stores computer instructions for causing a computer to perform the method for the early termination provided by the present disclosure.

The memory 802 which is a non-transitory computer readable storage medium may be configured to store non-transitory software programs, non-transitory computer executable programs and modules, such as program instructions/modules corresponding to the method for the early termination in embodiments of the present disclosure. The processor 801 executes various functional applications and data processing of a server, that is, implements the method for the early termination in the above-mentioned method embodiments, by running the non-transitory software programs, instructions, and modules stored in the memory 802.

The memory 802 may include a program storage area and a data storage area, the program storage area may store an operating system and an application program required for at least one function, and the data storage area may store data created according to use of the communication device for positioning, or the like. Furthermore, the memory 802 may include a high-speed random access memory, or a non-transitory memory, such as at least one magnetic disk storage device, a flash memory device, or other non-transitory solid state storage devices. In some embodiments, the memory 802 may include memories remote from the processor 801, and such remote memories may be connected to the communication device for positioning via a network. Examples of such a network include, but are not limited to, the Internet, intranets, local area networks, mobile communication networks, and combinations thereof.

The communication device for executing the method for the early termination may further include an input apparatus 803 and an output apparatus 804. The processor 801, the memory 802, the input apparatus 803 and the output apparatus 804 may be connected by a bus or other means, and FIG. 8 takes the connection by a bus as an example.

The input apparatus 803 may receive input numeric or character information and generate key signal input related to user settings and function control of the communication device for positioning, such as a touch screen, a keypad, a mouse, a track pad, a touch pad, a pointing stick, one or more mouse buttons, a trackball, a joystick and other input apparatuses. The output apparatus 804 may include a display device, an auxiliary lighting apparatus (for example, an LED) and a tactile feedback apparatus (for example, a vibrating motor), or the like. The display device may include, but is not limited to, a liquid crystal display (LCD), a light emitting diode (LED) display, and a plasma display. In some implementations, the display device may be a touch screen.

Various implementations of the systems and technologies described here may be implemented in digital electronic circuitry, integrated circuitry, ASICs (application specific integrated circuits), computer hardware, firmware, software, and/or combinations thereof. These various implementations may be implemented in one or more computer programs which are executable and/or interpretable on a programmable system including at least one programmable processor, and the programmable processor may be special or general, and may receive data and instructions from, and transmitting data and instructions to, a storage system, at least one input apparatus, and at least one output apparatus.

These computer programs (also known as programs, software, software applications, or codes) include machine instructions for a programmable processor, and may be implemented using high-level procedural and/or object-oriented programming languages, and/or assembly/machine languages. As used herein, the terms “machine readable medium” and “computer readable medium” refer to any computer program product, device and/or apparatus (for example, magnetic discs, optical disks, memories, programmable logic devices (PLDs)) for providing machine instructions and/or data to a programmable processor, including a machine readable medium which receives machine instructions as a machine readable signal. The term “machine readable signal” refers to any signal for providing machine instructions and/or data to a programmable processor.

To provide interaction with a user, the systems and technologies described here may be implemented on a computer having: a display apparatus (for example, a Cathode Ray Tube (CRT) or Liquid Crystal Display (LCD) monitor) for displaying information to the user; and a keyboard and a pointing apparatus (for example, a mouse or a trackball) by which the user may provide an input to the computer. Other kinds of apparatuses may also be used to provide interaction with the user; for example, feedback provided to a user may be any form of sensory feedback (for example, visual feedback, auditory feedback, or tactile feedback); and the input from the user may be received in any form (including acoustic, voice or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a Local Area Network (LAN), a Wide Area Network (WAN) and the Internet.

A computer system may include a client and a server. Generally, the client and the server are remote from each other and interact through the communication network. The relationship between the client and the server is generated by virtue of computer programs which are run on respective computers and have a client-server relationship to each other.

The terminal monitors the PDCCH carrying the downlink control information DCI according to the time unit that is configured, and terminates the repeated transmission of the HD-FDD terminal according to the indication information of the DCI information domain. Thus, in the scenario of the coverage enhancement, the energy saving of the HD-FDD terminal is achieved.

According to a first aspect of the present disclosure, a method for an early termination is provided, performed by a half-duplex frequency division duplexing HD-FDD terminal, and the method includes: monitoring, according to a time unit configured, a physical downlink control channel PDCCH carrying downlink control information DCI; terminating, according to indication information of a DCI information domain, a repeated transmission of the HD-FDD terminal.

In an embodiment, the method further includes one of the following: determining, according to a preset protocol, the time unit; or, receiving a control signal carrying the time unit, wherein the control signal is sent by a network device.

In an embodiment, the time unit configured is before an end of the repeated transmission.

In an embodiment, the monitoring, according to the time unit configured, the PDCCH carrying the downlink control information DCI includes one of the following: monitoring the PDCCH carrying the DCI in response to that at least one fixed time unit configured is reached; or monitoring the PDCCH carrying the DCI after at least one reference time unit configured.

In an embodiment, the reference time unit is related to a quantity of repeated transmission configured by the HD-FDD terminal.

In an embodiment, the monitoring, according to the time unit configured, the PDCCH carrying the downlink control information DCI includes: monitoring, according to the time unit configured, a PDCCH carrying a target DCI format.

In an embodiment, the target DCI format includes: an uplink (UL) grant DCI format.

According to a second aspect of the present disclosure, a method for an early termination is provided, performed by a network device, and the method includes: configuring an early termination function for an HD-FDD terminal; indicating, through downlink control information DCI, the HD-FDD terminal to terminate a repeated transmission early.

In an embodiment, the method further includes: configuring, for the HD-FDD terminal, a time unit for monitoring the DCI.

In an embodiment, the configuring the early termination function for the HD-FDD terminal includes: determining, according to an application scenario, an early termination function not prohibiting the repeated transmission of the HD-FDD terminal, and configuring, in a case of the HD-FDD terminal being configurable, the early termination function for the HD-FDD terminal.

In an embodiment, the method further includes: determining, according to an application scenario, an early termination function prohibiting the repeated transmission of the HD-FDD terminal.

In an embodiment, the indicating, according to the downlink control information DCI, that the HD-FDD terminal terminates the repeated transmission early includes: indicating that the HD-FDD terminal terminates the repeated transmission early through a target DCI format.

In an embodiment, the target DCI format includes: an uplink (UL) grant DCI format.

According to a third aspect of the present disclosure, an apparatus for an early termination is provided, applied to an HD-FDD terminal, and the apparatus includes: a monitoring module, configured to monitor, according to a time unit configured, a PDCCH carrying downlink control information DCI; a termination module, configured to terminate, according to indication information of the DCI information domain, a repeated transmission of the HD-FDD terminal.

According to a fourth aspect of the present disclosure, an apparatus for an early termination is provided, applied on a network device, and the apparatus includes: a configuration module, configured to configure an early termination function for an HD-FDD terminal; an indication module, configured to indicate, through downlink control information DCI, that the HD-FDD terminal terminates a repeated transmission early.

According to a fifth aspect of the present disclosure, a communication device is provided and includes a processor, a transceiver, a memory and executable programs running on the processor; wherein when the processor runs the executable programs, the method for the early termination according to the first aspect or the second aspect is performed.

According to a sixth aspect of the present disclosure, a non-transitory processor-readable storage medium, wherein the processor-readable storage medium stores a computer program and the computer program causes a processor to execute the method for the early termination according to the first aspect or the second aspect.

The method and apparatus for the early termination, the device, and storage medium proposed in the present disclosure have at least the following technical effects:

For the HD-FDD terminal, when the terminal repeatedly sends uplink data, a time unit for downlink monitoring is specified, and the indication for the early termination of downlink is monitored by using the time unit for the downlink monitoring, such that the HD-FDD terminal achieves the power saving.

It should be understood that various forms of the flows shown above may be used and reordered, and steps may be added or deleted. For example, individual steps described in the present disclosure may be executed in parallel, sequentially, or in different orders, and are not limited herein as long as the desired results of the technical solution disclosed in the present disclosure may be achieved.

The above-mentioned specific embodiments do not limit the protection scope of the present disclosure. It should be understood by those skilled in the art that various modifications, combinations, sub-combinations and replacements may be made depending on design requirements and other factors. Any modifications, equivalent replacements, and improvements made within the spirit and principles of the present disclosure should be included within the protection scope of the present disclosure.

1. A method for an early termination, performed by a half-duplex frequency division duplexing HD-FDD terminal, comprising:
monitoring, according to a time unit configured, a physical downlink control channel PDCCH carrying downlink control information (DCI); and
terminating, according to indication information of a DCI information domain, a repeated transmission of the HD-FDD terminal.

2. The method according to claim 1, further comprising one of the following:
determining, according to a preset protocol, the time unit; or,
receiving a control signal carrying the time unit, wherein the control signal is sent by a network device.

3. The method according to claim 1, wherein
the time unit configured is before an end of the repeated transmission.

4. The method according to claim 1, wherein the monitoring, according to the time unit configured, the PDCCH carrying the DCI comprises one of the following:
monitoring the PDCCH carrying the DCI in response to that at least one fixed time unit configured is reached; or
monitoring the PDCCH carrying the DCI after at least one reference time unit configured.

5. The method according to claim 1, wherein the monitoring, according to the time unit configured, the PDCCH carrying the DCI comprises monitoring the PDCCH carrying the DCI after at least one reference time unit configured:
wherein the reference time unit is related to a quantity of repeated transmission configured by the HD-FDD terminal.

6. The method according to claim 1, wherein the monitoring, according to the time unit configured, the PDCCH carrying the DCI comprises:
monitoring, according to the time unit configured, a PDCCH carrying a target DCI format.

7. The method according to claim 6, wherein the target DCI format comprises:
an uplink (UL) grant DCI format.

8. A method for an early termination, performed by a network device, comprising:
configuring an early termination function for a half-duplex frequency division duplexing (HD-FDD) terminal; and
indicating, through downlink control information (DCI), the HD-FDD terminal to terminate a repeated transmission early.

9. The method according to claim 8, further comprising:
configuring, for the HD-FDD terminal, a time unit for monitoring the DCI.

10. The method according to claim 8, wherein the configuring the early termination function for the HD-FDD terminal comprises:
determining, according to an application scenario, an early termination function not prohibiting the repeated transmission of the HD-FDD terminal, and configuring, in a case of the HDD-FDD terminal being configurable, the early termination function for the HD-FDD terminal.

11. The method according to claim 10, further comprising:
determining, according to an application scenario, an early termination function prohibiting the repeated transmission of the HD-FDD terminal.

12. The method according to claim 8, wherein the indicating, according to the DCI, that the HD-FDD terminal terminates the repeated transmission early comprises:
indicating that the HD-FDD terminal terminates the repeated transmission early through a target DCI format.

13. The method according to claim 9, wherein the target DCI format comprises:
an uplink (UL) grant DCI format.

14-15. (canceled)

16. A communication device, comprising a processor, a transceiver, a memory and executable programs running on the processor; wherein when the processor runs the executable programs, the processor is configured to:
monitor, according to a time unit configured, a physical downlink control channel (PDCCH) carrying downlink control information (DCI); and
terminate, according to indication information of a DCI information domain, a repeated transmission of a half-duplex frequency division duplexing (HD-FDD) terminal.

17. (canceled)

18. The communication device according to claim 16, wherein the processor is further configured to:
determine, according to a preset protocol, the time unit; or,
receive a control signal carrying the time unit, wherein the control signal is sent by a network device.

19. The communication device according to claim 16, wherein the time unit configured is before an end of the repeated transmission.

20. The communication device according to claim 16, wherein the processor is further configured to:
monitor the PDCCH carrying the DCI in response to that at least one fixed time unit configured is reached; or
monitor the PDCCH carrying the DCI after at least one reference time unit configured.

21. The communication device according to claim 16, wherein the processor is further configured to:
monitor the PDCCH carrying the DCI after at least one reference time unit configured;
wherein the reference time unit is related to a quantity of repeated transmission configured by the HD-FDD terminal.

22. The communication device according to claim 16, wherein the processor is further configured to: monitor, according to the time unit configured, a PDCCH carrying a target DCI format.

23. A communication device, comprising a processor, a transceiver, a memory and executable programs running on the processor; wherein when the processor runs the executable programs, the method for the early termination according to claim 8 is performed.
